(19) United States
(12) Patent Application Publication
(10) Pub. No.: US 2005/0142400 A1
(43) Pub. Date: Jun. 30, 2005

(54) Safe purging of water from fuel cell stacks

(75) Inventors: Francesco Turco, Brookline, MA (US); Ware D. Fuller, Acton, MA (US)

Correspondence Address: MUSERLIAN, LUCAS AND MERCANTI, LLP, 475 PARK AVENUE SOUTH, 15TH FLOOR, NEW YORK, NY, 10016, US

(73) Assignee: Nuvera Fuel Cells

(21) Appl. No.: 10/989,163

(22) Filed: Nov. 15, 2004

Related U.S. Application Data
(60) Provisional application No. 60/534,348, filed on Dec. 31, 2003.

(51) Int. Cl. H01M 8/04

(52) U.S. Cl. 429/13; 429/17; 429/34

(57) ABSTRACT

Methods and devices are provided for purging fuel cells of water and accumulated non-reactive gases whereby the systems are constructed to dilute any emitted hydrogen below its inflammability limit for increased safety.

### PRIOR APPLICATION

This application claims the benefit of U.S. Provisional Patent Application Ser. No. 60/534,348 filed Dec. 31, 2003.

### BACKGROUND OF THE INVENTION

There is increasing interest in fuel cells for various uses and, in particular, the “PEM” type of fuel cell is of great interest, especially for smaller or mobile operations. In a PEM fuel cell, hydrogen is catalytically decomposed on one side of a membrane, the protons pass through the membrane, and the electrons, after doing work as an electric current, unite with the protons and with oxygen to produce water and heat.

One attractive feature of PEM cells is that they operate at relatively low temperatures, in the range of about 60 to 100° C. This improves speed of startup, and improves safety. However, the low temperature PEM cell has the disadvantage of typically operating below the boiling point of water which allows product water to accumulate in the fuel cell, where it can block access of gas to the active membrane, as is well known (c.f. U.S. Pat. No. 2,913,511). The problem is particularly acute when fuel cells are assembled in series into a fuel cell stack (a “stack”), since the stack has manifolding to deliver air and hydrogen to the individual cells which manifolding provides an additional place where water can accumulate.

The problem of water management is further exacerbated by the necessity to keep the membrane wet, since water absorbed on charged groups in the membrane is the route through which protons pass through the membrane. Moreover, the passage of protons through the membrane tends to drag water molecules through the membrane. As a result, water can accumulate either on the cathode (oxygen consuming side), or the anode (hydrogen-consuming side) of the membrane, or both, depending on details of system construction and operation.

A variety of solutions to the problem have been proposed including arranging flow directions, using wicks, using particular cooling arrangements, and purging the water from the stack by means of gas pressure, as described below. Purging the cathode side is straightforward, because air is inexpensive, safe, and normally supplied in excess of the hydrogen to be consumed. Purging the anode side, however, tends to entail release of hydrogen and releasing hydrogen not only reduces the efficiency of the fuel cell, but can also create a hazardous gas mixture.

In U.S. Pat. No. 5,478,662 (Strasser), significant loss of hydrogen purging is prevented by passing the hydrogen, as it is depleted, past a decreasing membrane area, so that the hydrogen is almost entirely consumed as the fuel flow leaves the fuel cell stack. This approach also solves the problem of the presence of non-hydrogen gases in the hydrogen, or diffusing into it (for example, nitrogen). However, no means is provided for effecting a vigorous purge to force water out of the fuel cell membrane area in the stack.

More commonly, water is removed from the anode by a purge with the hydrogen fuel. Generally, the water is forced into a water/fuel separator, from which the hydrogen is recycled or burned. In U.S. Pat. No. 5,366,818 (Wilkinson et al), the hydrogen is repressurized by a pump, deionized, and fed back into the fuel flow through a check valve. In U.S. Pat. No. 6,663,990 (Io et al), a draw pump is used to pull hydrogen through the anode and carry water with it. EP 1018774 (Charlat) uses a reservoir into which a hydrogen purge can force water, and then allows the hydrogen to be consumed by the stack or to be returned to the stack via a hydrogen-selective membrane, or via a check valve. Then, periodically, the contents of the reservoir are vented, thereby removing water, unwanted gases, and inevitably some hydrogen. This is not a problem when the stack is operated in associated with a fuel reformer, since the reformer can burn the anode gas to provide heat for the reforming reaction. But in a standalone stack operating on hydrogen, the release of hydrogen affects not only efficiency, but also safety.

None of the above proposals addresses the problem of safety. Hydrogen has a very low “lower flammability limit” in air, less than about 2 percent by volume and mixtures containing more hydrogen than that, can potentially be ignited by any heat source. When fuel cells are to be used in buildings, or in automobiles, the generation of a flammable mixture is generally not considered to be acceptable. This is a problem that has to be solved when using purified hydrogen in fuel cells.

### OBJECTS OF THE INVENTION

It is an object of the invention to provide a method of providing an efficient purging cycle with a minimum loss of hydrogen and increased safety.

It is another object of the invention to provide a fuel cell stock provided with means to prevent the release of hydrogen in a flammable concentration.

These and other objects and advantages of the invention will become obvious from the following detailed description.

### THE INVENTION

In one aspect, the invention comprises an apparatus designed to prevent the release of hydrogen in a flammable concentration from a fuel cell stack. The anode compartment of the fuel cell is purged, periodically or at variable intervals, and the anode gas, preferably after at least partial removal of hydrogen by the action of the stack, is released through a calibrated orifice, or a functionally similar flow restriction. The calibrated orifice leads into a conduit that carries the cathode gas that is leaving the stack, and the anode and cathode gases mix. The orifice is sized so that, at the maximum designed or possible pressure in the anode compartment, and at the normal or lowest normal operating pressure of the cathode compartment, the flow rate of anode gas will be sufficiently low that its concentration, after mixing with the cathode gas, will not exceed the lower flammable limit (LFL) of hydrogen in air. Preferably, a significant margin of safety is provided, so that the final concentration is less than one half of the LFL or, more preferably, less than one quarter of the LFL.

In another aspect of the invention, a method is provided for operating a fuel cell stack so as to allow purging of water from the stack while keeping the hydrogen concentration in the efflux from the cell below the LFL. In another aspect of the invention, particular patterns of opening and closing of valves are used to conduct purges efficiently and with little hydrogen loss.

### BRIEF DESCRIPTION OF THE DRAWINGS

FIG. 1 shows a preferred anode purge apparatus.

FIG. 2 shows the pressure curves expected during the use of the apparatus of FIG. 1.

FIG. 3 shows results of using the purge cycles of the invention.

### DETAILED DESCRIPTION OF THE INVENTION

The invention comprises a preferred regulatory means for controlling hydrogen concentration, apparatuses for implementing a controlled hydrogen purge in the context of purges to remove water from a stack, and methods of operating the apparatus.

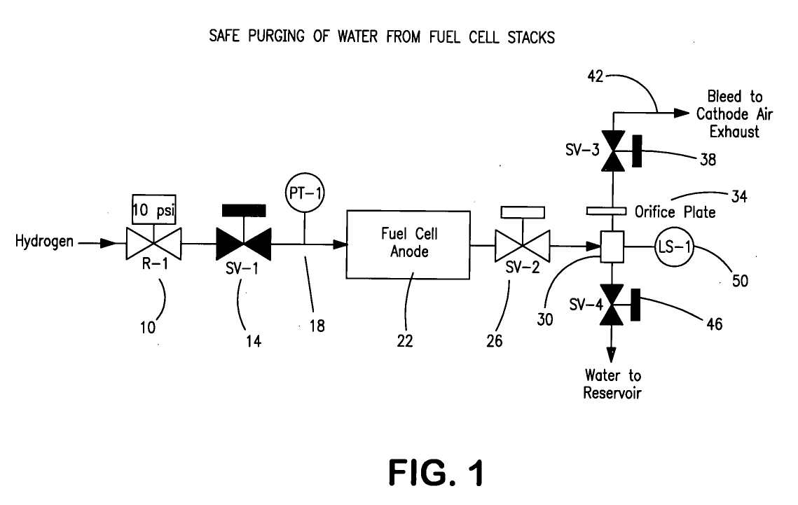

A schematic diagram of a preferred embodiment of the regulatory system is shown in FIG. 1 which shows an anode (fuel) compartment of a fuel cell stack, and the system regulating the supply of hydrogen to and the venting of hydrogen from a fuel cell stack. Hydrogen is fed via a pressure regulator 10 to a normally-closed solenoid valve 14, and then into fuel cell anode compartment 22. A pressure sensor 18 can be located on the inlet to the fuel cell (as shown) or at the outlet. Anode exhaust, containing hydrogen as well as non-combustible gases from the fuel and from the air by diffusion across the membrane, leaves the anode compartment via a normally-open solenoid valve 26, and passes into recycle tank 30. Anode exhaust flows into recycle tank 30, and, during purging, through a calibrated orifice in orifice plate 34, and then through a normally-closed solenoid valve 38. Anode exhaust then passes through exhaust tube 42 to eventually mix with the cathode exhaust (not shown) and then exit from the system.

The recycle tank 30 collects water carried from the stack by the anode exhaust, and separates the water from the exhaust. Water is removed from recycle tank 30 via a normally-closed solenoid valve 46 and water removal is initiated by signals from a level detector 50.

Although not illustrated, the solenoid valves, optionally the pressure regulator, and any sensors, such as pressure sensor or 18 and level sensor 50, are connected to a microprocessor or other type of system controller, which opens and closes valves in response to time or signals, and which typically operates other parts of the system. The controller, whether local or remote, typically stores routines to handle the entire purge cycle.

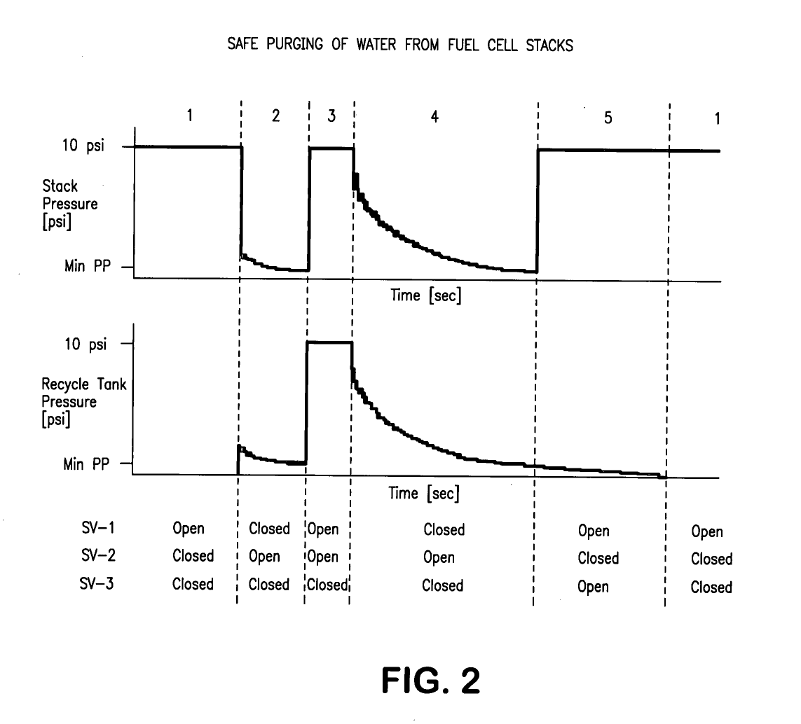

There are several ways in which this system can be operated. A preferred mode is as follows, for a system in which water accumulation is in the anode compartment. The system has six operating states, labeled 1 through 6 in Table 1 below. The positions of each of the valves (O for Open, C for Closed, or -- for indifferent) are indicated. Transitions between operating states are described below. Five of the six states are shown in FIG. 2, which shows the pressure in the stack and in the recycle tank. The horizontal extent of the stages is schematic, and not proportional to actual sub-cycle lengths.

TABLE 1

| State: | 1 | 2 | 3 | 4 | 5 | 6 |
|---|---|---|---|---|---|---|
| Valve | Normal | Evac/Purge | PurgeAnod | Evac | PurgeRecy | Drain |
| 14 | O | C | O | C | O | — |
| (SV-1) | | | | | | |
| 26 | C | O | O | O | C | C |
| (SV-2) | | | | | | |
| 38 | C | C | C | C | O | C |
| (SV-3) | | | | | | |
| 46 | — | C | C | C | C | O |
| (SV-4) | | | | | | |

In normal operation (State 1), valve or 14 is open, and valves 26 and 38 are closed. The anode operates in “dead end” mode, and hydrogen is continually supplied to the stack.

Water is accumulating in the anode compartment 22, at a rate that is approximately proportional to the current output of the fuel cell. The pressure in the anode compartment 22 is controlled by regulator 10, for example at about 10 PSI (ca. 0.66 bar; ca. 66 kPa) above gauge. In State 1, the pressure in the anode is the set pressure, and the pressure in the recycle tank is usually low (near gauge). This is shown in the first panel of FIG. 2. After a time, which may be fixed, or which preferably is calculated based on stack output, the system state is changed to State 2.

State 2 is a purge and evacuate cycle in which valve or 14 is closed and valve 26 is opened, preferably simultaneously. During this transition, pressure imbalance between the anode compartment 22 and the recycle tank 30 will push water out of the anode compartment and into the recycle tank 30. In State 2, after the initial purge, no hydrogen is being supplied to the stack (or to the recycle tank), and the pressure inside the anode compartment 22 and the recycle tank 30 drops rapidly due to the consumption of hydrogen by the stack. Hydrogen flows back from the recycle tank to the stack as the stack consumes it and the pressure decreases as the hydrogen is consumed.

At a limiting minimum pressure Pm, or upon calculation or timing, the system moves to State 3, in which the anode compartment 22 is pressurized. (Failure of the pressure to fall to Pm, or slowness in attaining it, can be used as a signal that it is time to purge the anode exhaust.) To create State 3, valve or 14 is opened, and hydrogen rushes into the stack anode compartment 22 and onward into the recycle tank 30. This is a second major step in purging water from the anode compartment 22 and moving it into the recycle tank 30. To understand the general range of pressure fluctuation, Pm might be 1 PSIG (ca. 7 kPa), while, as illustrated in FIG. 2, the stack may be pressurized to 10 PSIG (Ca. 70 kPa). State 3 is ended after the anode compartment returns to normal pressure, as measured by the gauge 18. This typically requires at most a few seconds, and is typically a timed step (vs. calculated) for simplicity.

The system then is moved to State 4, in which the anode compartment is drained, by closing valve 14. When hydrogen has been depleted in both the anode compartment 22 and the recycle tank 30, as measured by the pressure gauge or 18 (or by timing or calculation), then the system is returned to State 1 by closing valve 26 (leaving the recycle tank at relatively low pressure) and then opening valve 14. The cycle then repeats. Typically, as confirmed experimentally, the system can repeat this cycle numerous times before having to purge either anode exhaust or water from the recycle tank 30.

Frequent purging of water from the anode compartment is desirable, because water rapidly accumulates and quickly begins to flood the membrane. However, because purging the recycle tank of anode exhaust vents hydrogen, the tank should be purged of anode exhaust as infrequently as is feasible. Practical limitations requiring purging of the anode exhaust include the accumulation of a significant amount of non-hydrogen gas, which will act as a diluent of the fuel and will thus tend to decrease the current output. Determination of the need to purge the exhaust can be based on one or more of calculation, of measurement (for example, of the speed of approach of compartment pressure to Pm during stage 2 or 4; or measurement of the accumulated current output), or of preset frequency (timing).

When it is time to purge anode exhaust from the system, the system leaves State 4 for State 5 by closing valve 26 and then opening valve or 14 and purge valve 38. This allows residual anode exhaust gas in the recycle tank 30 to pass through the orifice plate 34 and through valve 38 into tube 42, in which it eventually is mixed with cathode exhaust or other diluting gas (not illustrated). The anode exhaust in the recycle tank has been substantially depleted of hydrogen, and has been accumulating non-reactive gas, especially nitrogen and carbon dioxide, for numerous cycles. Hence, an absolute minimum of hydrogen is lost during the exhaust purge cycle. Meanwhile, the stack is otherwise in the normal operating state.

The duration of State 5 can be nearly as long as a cycle of State 1, if needed. The limitation is the onset of stack flooding, which decreases stack output, but preferably the purge cycle is started before that point. To return to State 1, the system closes valve 38. In turn, State 1 can proceed to State 2, immediately if needed, by closing valve or 18 and opening valve 26.

State 6 is for removal of water from the recycling tank 30. Like State 5, it can occur whenever SV-2 and SV-3 (valves 26 and 38) are closed, which is State 1. Valve 46 is opened, and the residual pressure in the recycle tank 30 drives water out of the recycle tank, usually to a system reservoir (not illustrated). Valve 46 is closed before the earlier of the initiation of State 2, and the complete draining of the water in the reservoir. The latter limit prevents the release of hydrogen into other parts of the system.

The limiting orifice plate 34 is constructed so that the maximum flow of hydrogen-containing anode exhaust through the orifice, at the highest anticipated pressure in the recycle tank and with pure hydrogen as the exhaust, remains below a critical rate. The critical rate, in the preferred embodiment, is determined by the flow rate of the cathode exhaust. This excess air is normally exhausted, directly or after a water-recovery step. Cathode air is normally provided in excess of the hydrogen supply, for example at a two-fold stoichiometric excess. This translates to an approximately ten-fold excess volumetric cathode flow. In such a case, the limiting flow needs to be below about 20% of the rate of hydrogen consumption. The actual required rate will be determined by the details of construction and operation of the particular system. Provision could also be made for adding compressed air to the cathode exhaust flow if further dilution was required.

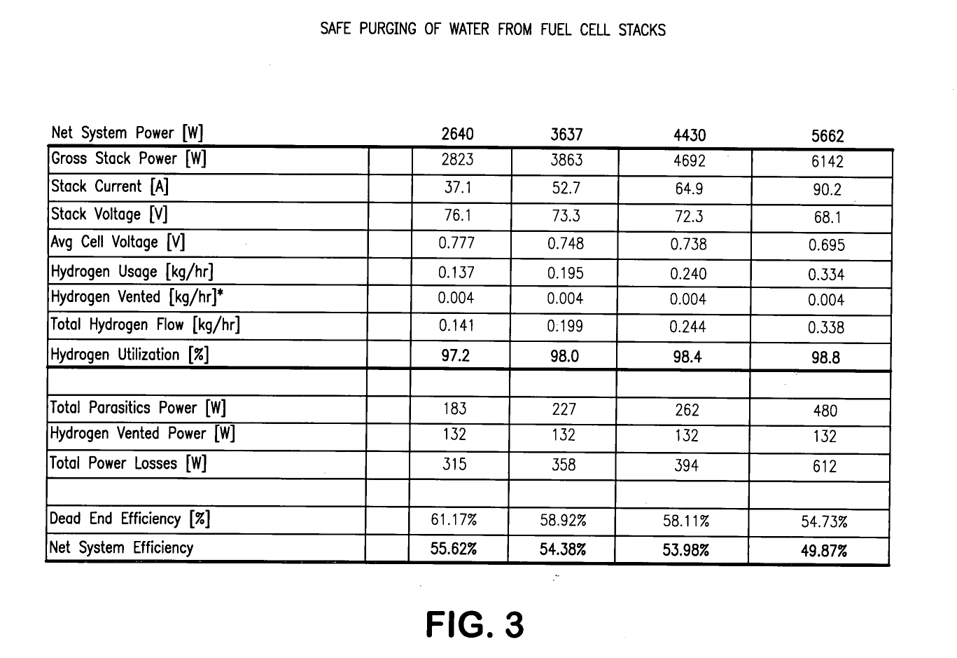

FIG. 3 illustrates the effects of using the system of the invention at various power levels in an operating fuel cell. The amount of hydrogen lost by venting is calculated from calculation of volumetric efflux from valve 38 during a purge cycle in State 5 (by measuring the area under the pressure curve), and assumes undepleted hydrogen and anode purging every cycle, which is a “worst case” assumption. Because cycling times were fixed in this experiment, hydrogen loss does not vary significantly when power is more than doubled. As a result, hydrogen utilization efficiency increases as power is raised, and the percent of hydrogen used rises from 97% to almost 99%. It is anticipated that with purging operating only every tenth cycle, or on “demand”, and with gas depleted in hydrogen being exhausted, a hydrogen loss from purging of less than 1% of use can be obtained at all power levels.

The system will normally have a pressure relief valve (not illustrated) at some point downstream of pressure regulator 10, to control hydrogen pressure in case of pressure valve malfunction. The pressure relief valve should preferable lead “outside” of the structure in which the fuel cell is housed, to an extent sufficient to prevent accumulation of hydrogen in a confined space. If possible, arrangements should be made to provide a significant air flow past the outlet of the pressure relief valve, to dilute the hydrogen.

The valves have been described as solenoid valves, but other types of valves could be used. A preferred configuration is to have valves 14, 38, and 46 of the normally closed type, and valve 26 as normally closed. However, if there is no provision for purging the system of hydrogen upon shut down, then one or both of valves 38 and 46 should be opened after shutdown to vent unused hydrogen; or another valve should be provided for this purpose. In addition, it is within the scope of the invention to use any combination of normally open and normally closed valves, of the solenoid type or otherwise, to control the flow of gases as described herein.

A convenient way to provide the calibrated orifice in orifice plate 34 is by use of the standard orifices available for use in furnaces and the like, which can be screwed into a plate. Alternatively, one or more calibrated holes can be made in a plate. The plate and orifice could be replaced by a length of narrow-bore tubing or pipe. Generally, any restriction which will reliably limit the flow of anode gas is suitable. The restriction could even be a pump, although that is less preferred. Any of these variations, and equivalent means of limiting gas flow, can be described as “flow limiting means”.

While it is less common, it is known to operate fuel cell stacks with pure oxygen, which is preferably not bypassed, but rather operated in dead end mode, as described above for hydrogen. In that case, purging the cathode compartment would be required. The present construction and procedures could also be applied to purge the cathode side of the stack. In such a case, the limiting orifice or equivalent would be less important. However, some other means for diluting the residual purged hydrogen would typically be required, such as an air blower, or a catalytic converter or a burner for combining bypassed hydrogen and oxygen. Synchronization of cathode and anode purges would be possible but not required. The limitation in determining whether to synchronize purge cycles would, in some cases, be the ability of the membrane to withstand pressure fluctuations without damage. This also limits the possible pressure fluctuations in the hydrogen purge aspect. The maximum allowable pressure will depend on the characteristics of the membrane, and on the character of its support in an electrode assembly.

While a particular embodiment of the invention has been described in detail, so that the working of the invention can be readily understood, numerous modifications within the scope of the claims will be apparent to those skilled in the art, in the light of these teachings, and such modifications fall within the invention.

1. A method for purging water or other liquid from one or both of the anode compartment and the cathode of a fuel cell stack, wherein the one or more compartments is connected to a regulated source of hydrogen or of oxygen via a first valve, and to a recycle tank via a second valve, said recycle tank further being connected to a third valve for purging gases and to a fourth valve for purging water or other liquid from the tank,
the method comprising (1) normal fuel cell operation with the first valve and the other valves are closed, (2) an anode purge with the first, third and fourth valves are closed and the second valve is open, (3) a pressurization stage wherein the first and second valves are open and the third and fourth valves are closed and (4) an evacuation stage wherein only the second valve is open and (5) return to the normal stage by opening the first valve again and closing the other valves.

2. The method of claim 1, further comprising a fifth state in which gas is purged from the tank, the fifth state being obtained from the first state by opening the third valve, and ended by closing the third valve, while the first valve is open and the second and fourth valves are closed.

3. The method of claim 2, further comprising a sixth state in which liquid is purged from the tank, the sixth state being obtained from the first state by opening the fourth valve, and ended by closing the fourth valve, while the first valve is open and the second and third valves are closed.

4. The method of claim 1, wherein the system further provides means for limiting the efflux rate of gases from the tank.

5. The method of claim 4 wherein the flow-limiting means is at least one of a prefabricated orifice, a calibrated hole in a barrier, a length of narrow diameter tubing, and a pump.

6. The method of claim 1, wherein the compartment is an anode compartment, wherein anode exhaust gases leaving the tank are forced to mix with a diluting flow of air before being exhausted from the system.

7. The method of claim 6, wherein the diluting flow is sufficient to reduce the hydrogen concentration in the resulting mixed flow to below the lower flammable limit of hydrogen in air.

8. The method of claim 7, where the diluting flow comprises a cathode exhaust.

9. The method of claim 2, wherein the fifth state is not entered after every cycle of states 1 through 4, but only on demand, by calculation, or by timing.

10. The method of claim 9, wherein the fifth state is entered on about every fifth cycle on average.

11. The method of claim 9, wherein the fifth state is entered on about every tenth cycle on average.

12. The method of claim 3, wherein the sixth state is not entered after every cycle of states 1 through 4, but only on demand, by calculation, or by timing.

13. The method of claim 12, wherein the sixth state is entered on about every fifth cycle on average.

14. A method for safely purging the anode compartment of a fuel cell stack, the method comprising the steps of:
a) collecting anode exhaust to be purged in a recycle tank downstream of the anode compartment;
b) isolating the recycle tank from the anode compartment;
c) activating a means for causing the escape of anode exhaust gas from the recycle compartment; and
d) mixing the escaping anode exhaust gas with a diluting volume of air, wherein the diluting air is sufficient to reduce the concentration of hydrogen in the mixed stream to below the lower flammable limit of hydrogen in air.

15. The method of claim 14 wherein the dilution is to a level below ¼^{th} of the lower flammable limit of hydrogen in air.

16. The method of claim 14 wherein the diluting air comprises the cathode exhaust of the fuel cell stack.

17. The method of claim 14 wherein the diluting air comprises air other than the cathode exhaust of the fuel cell stack.

18. The method of claim 14 wherein the escaping anode exhaust gas is passed through a flow-limiting means before it is mixed with diluting air.

19. The method of claim 18 wherein the flow-limiting means is at least one of a prefabricated orifice, a calibrated hole in a barrier, a length of narrow diameter tubing, and a pump.

20. The method of claim 18 wherein the flow of anode exhaust is further regulated by a valve.

21. An apparatus for purging a fuel cell stack of fluid or gas present in one or both of the anode and cathode compartments, wherein the apparatus comprises a fuel cell stack having an anode compartment and a cathode compartment,
and wherein each compartment to be purged is connected to a regulated source of hydrogen or of oxygen via a first valve, and to a recycle tank via a second valve, said recycle tank further being connected to a third valve for purging gases and to a fourth valve for purging water or other liquid from the tank,
the apparatus further comprising a pressure sensor connected to each compartment to be purged, and a controller to sequence the opening and closing of valves based on input from the pressure sensor, and based on timing or calculation, and optionally based on input from one or more other sensors.

22. The apparatus of claim 21 further comprising a flow-regulating means in a line beyond the third valve for limiting the rate of escape of hydrogen-containing anode exhaust from the recycle tank.

23. The apparatus of claim 21 further comprising means for mixing anode exhaust leaving the third valve with a source of diluting air.

24. The apparatus of claim 23 wherein the dilution is to a level below ¼^{th} of the lower flammable limit of hydrogen in air.

25. The apparatus of claim 23 wherein the diluting air comprises the cathode exhaust of the fuel cell stack.

26. The apparatus of claim 23 wherein the diluting air comprises air other than the cathode exhaust of the fuel cell stack.

27. The apparatus of claim 22 wherein the escaping anode exhaust gas is passed through a flow-limiting means before it is mixed with diluting air.

28. The apparatus of claim 22 wherein the flow-limiting means is at least one of a prefabricated orifice, a calibrated hole in a barrier, a length of narrow diameter tubing, and a pump.

29. The apparatus of claim 21 wherein the controller is constructed and arranged to provide a series of states for purging the one or more fuel cell stack compartments, each state having a set of valves open and the other valves closed, wherein in a first state only the first valve is open; in a second state only the second valve is open; in a third state the first and second valves are open; in a fourth state only the second valve is open; and the first state follows the fourth state.

30. The apparatus of claim 21 wherein a fifth state is provided by opening the third valve while the second valve and the fourth valve are closed, thereby purging gas from the recycle tank.

31. The apparatus of claim 21 wherein a sixth state is provided by opening the fourth valve while the second valve and the third valve are closed, thereby purging liquid from the recycle tank.

32. The apparatus of claim 20 wherein purging of the recycle tank via the third valve does not occur at every opportunity to do so.

33. The apparatus of claim 23 wherein purging of the recycle tank via the fourth valve does not occur at every opportunity to do so.

34. The apparatus of claim 21 wherein the system further provides means for limiting the efflux rate of gases from the recycle tank.
